(19) United States
(12) Patent Application Publication
(10) Pub. No.: US 2015/0172304 A1
(43) Pub. Date: Jun. 18, 2015

(54) SECURE BACKUP WITH ANTI-MALWARE SCAN

(71) Applicant: Malwarebytes Corporation, San Jose, CA (US)

(72) Inventor: Marcin Kleczynski, Chicago, IL (US)

(73) Assignee: Malwarebytes Corporation, San Jose, CA (US)

(21) Appl. No.: 14/108,285

(22) Filed: Dec. 16, 2013

(51) Int. Cl. H04L 29/06

(52) U.S. Cl. CPC H04L 63/1416; H04L 63/1441

(57) ABSTRACT

A secure backup application executing on the computing device routinely backs up files on the device to a cloud backup server. Prior to backing up a particular file, the secure backup application performs a malware detection scan on the file to determine whether the files are malware. If a file is malware and cannot be cleaned, then the file is not backed up. Similarly, the secure backup application performs a malware detection scan on files that are being restored to a computing device from the cloud backup server. If a file retrieved from the cloud backup server is determined to be malware, then the secure backup application prevents the file from being fully restored and quarantines or expunges the file from the computing device.

### FIELD OF ART

The present disclosure is generally related to malware detection and more specifically to securely backing up files using malware detection.

### BACKGROUND

In cloud storage systems, backup data from a computing device is transmitted to and stored by a cloud service provider, which manages the storage of the backup data on behalf of the device. Files from a device that are backed up in cloud storage may be infected by malicious software before those files were backed up. Malicious software, also known as malware, is designed to perform a malicious task within a targeted computing device. For example, malware may be used to disrupt computer operations, gather sensitive information or gain access to private information in these targeted computing devices. Backing up infected files has several serious consequences. For example, even if a user cleans her device of the malicious software, when the infected files are restored from the cloud storage, the device may be infected again. Further, files that are backed up from one device are transmitted to an additional device, such as a secondary device belonging to the same user as the primary device or a device belonging to a different user with whom the files are to be shared. In such a case, when the files are restored from the cloud storage, the additional device may also be infected.

### SUMMARY

A secure backup application executing on the computing device securely backs up files on the device to a cloud backup server such that infected files are prevented from being backed up. Before backing up a particular file, the secure backup application performs a malware detection scan on the file to determine whether the file is malware. The detection may be based on a known set of malware definitions or based on heuristics. If a file is malware, then the file is not backed up. Consequently, only the files that are not malware are backed up to the cloud backup server. Similarly, the secure backup application performs a malware detection scan on files that are backed up in the cloud backup server and are being restored to a computing device. If a file retrieved from the cloud backup server is determined to be malware, then the secure backup application prevents the file from being fully restored and expunges the file from the computing device.

### BRIEF DESCRIPTION OF THE DRAWINGS

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

FIG. 1 is a high-level block diagram illustrating a system environment for a secure backup application, in accordance with an embodiment.

FIG. 2 is a flow diagram illustrating a process for securely backing up files to a cloud backup server, in accordance with an embodiment.

FIG. 3 is a flow diagram illustrating a process for securely restoring files from a cloud backup server, in accordance with an embodiment.

### DETAILED DESCRIPTION

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

Files stored on a computing device are securely backed up and restored using the techniques described herein. In operation, a secure backup application executing on the computing device routinely backs up files on the device to a cloud backup server. Prior to backing up a particular file, the secure backup application performs a malware detection scan on the file to determine whether the file is malware. If a file is malware and cannot be cleaned, then the secure backup application prevents the file from being backed up. Similarly, the secure backup application performs a malware detection scan on previously backed up files prior to restoring these files to a computing device. If the secure backup application determines that a file retrieved from the cloud backup server is malware, then the secure backup application prevents the file from being fully restored and quarantines or expunges the file from the computing device. This process ensures the integrity of files on the cloud backup server and prevents malware from infecting additional computing devices.

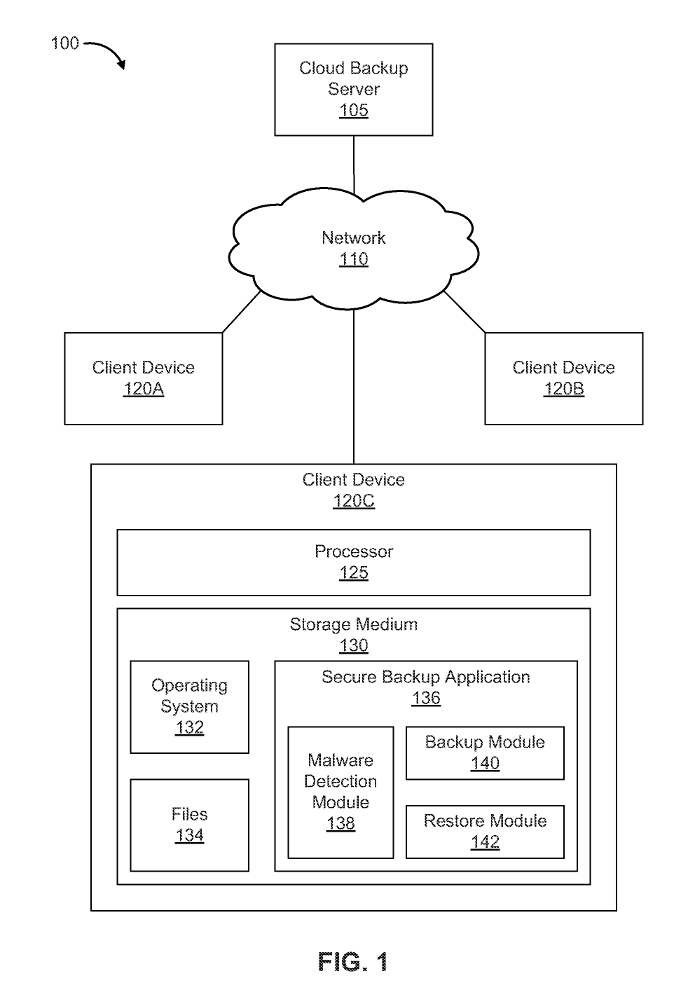

FIG. 1 is a high-level block diagram illustrating a system environment 100 for a secure backup application. The system environment 100 comprises a cloud backup server 105, a network 110, and various client devices 120A, 120B, 120C (collectively referenced herein as client devices 120). For simplicity and clarity, only one cloud backup server 105 and a limited number of client devices 120 are shown; however, other embodiments may include different numbers of servers 105 and client devices 120. Furthermore, the system environment 100 may include different or additional entities.

The cloud backup server 105 is a computer system configured to store, receive, and transmit data to the client devices 120 via the network 110. The cloud backup server 105 may include a singular computing system, such as a single computer, or a network of computing systems, such as a data center or a distributed computing system. The cloud backup server 105 provides a cloud backup service that enables the client devices 120 to (i) backup data files in cloud storage provided by the cloud backup server 105 and (ii) restore such backed up data files from the cloud storage.

The network 110 represents the communication pathways between the cloud backup server 105 and client devices 120. In one embodiment, the network 110 is the Internet. The network 110 can also utilize dedicated or private communications links that are not necessarily part of the Internet. In one embodiment, the network 110 uses standard communications technologies and/or protocols. Thus, the network 110 can include links using technologies such as Ethernet, Wi-Fi (802.11), integrated services digital network (ISDN), digital subscriber line (DSL), asynchronous transfer mode (ATM), etc. Similarly, the networking protocols used on the network 110 can include multiprotocol label switching (MPLS), the transmission control protocol/Internet protocol (TCP/IP), the hypertext transport protocol (HTTP), the simple mail transfer protocol (SMTP), the file transfer protocol (FTP), etc. In one embodiment, at least some of the links use mobile networking technologies, including general packet radio service (GPRS), enhanced data GSM environment (EDGE), long term evolution (LTE), code division multiple access 2000 (CDMA2000), and/or wide-band CDMA (WCDMA). The data exchanged over the network 110 can be represented using technologies and/or formats including the hypertext markup language (HTML), the extensible markup language (XML), the wireless access protocol (WAP), the short message service (SMS) etc. In addition, all or some of the links can be encrypted using conventional encryption technologies such as the secure sockets layer (SSL), Secure HTTP and/or virtual private networks (VPNs). In another embodiment, the entities can use custom and/or dedicated data communications technologies instead of, or in addition to, the ones described above.

Each client device 120 comprises one or more computing devices capable of processing data as well as transmitting and receiving data via the network 110. For example, a client device 120 may be a desktop computer, a laptop computer, a smart phone, a tablet computing device, or any other device having computing and data communication capabilities. The remainder of this discussion focuses on example client device 120C (also referred to as client device 120). Persons skilled in the art would recognize that each of the client devices 120 may be configured to operate in the same or similar manner as client device 120C.

The client device 120C includes a processor 125 for manipulating and processing data, and a storage medium 130 for storing data and program instructions associated with various applications. The storage medium 130 may include both volatile memory (e.g., random access memory) and non-volatile storage memory such as hard disks, flash memory, flash drives, external memory storage devices, USB drives, discs and the like. As shown, the storage medium 130 stores an operating system 132, files 134 and a secure backup application 136.

In one embodiment, the storage medium 130 comprises a non-transitory computer-readable storage medium. The various applications (e.g., the operating system 132 and the secure backup application 136) are each embodied as computer-executable instructions stored to the non-transitory computer-readable storage medium. The instructions, when executed by the processor 125, cause the client device 120C to perform the functions attributed to the applications described herein. For example, when secure backup application 136 executes, either in response to a user command or an automated script, the processor 125 accesses the secure backup application 136 in the storage medium 130 and creates a process. The processor 125 then executes the program instructions associated with the process or thread. This execution may include access to other files in the storage medium 130.

The operating system 132 is a specialized application that manages computer hardware resources of the client device 120C and provides common services to applications executing within the client device 120C. For example, a computer's operating system 132 may manage the processor 125 or other components not illustrated such as, for example, a storage medium, a graphics adapter, an audio adapter, network connections, disc drives, USB slots, and applications. A cell phone's operating system 132 may manage the processor 125, storage medium, display screen, key pad, dialer, wireless network connections and the like. Because many programs and executed processes compete for the limited resources provided by the processor 125, the operating system 132 may manage the processor bandwidth and timing to each requesting process. Examples of operating systems 134 include WINDOWS, MAC OS, IOS, LINUX, UBUNTU, UNIX, and ANDROID.

The files 134 include data generated and used by the various applications, including the operating system 132, executing on the client device 120C. The files 134 may include text, audio and/or video data and may be organized into a known file system format, such as File Allocation Table (FAT) or New Technology File System (NTFS). Users of the client device 120C interact with the files 134 in a variety of ways. For example, users may view, edit, share or delete any one of the files 134 using functionality provided by the operating system 132 or other types of applications (not shown) executing on the client device 120C.

The secure backup application 136 facilitates secure backup of one or more of the files 134 in the cloud backup server 105. In this context, the term “backup” refers to storing a copy of a file present within the storage medium 130 in the storage provided by the cloud backup server 105. Files that are backed up in the cloud backup server 105 remain unaltered until they are replaced or deleted. Regularly backing up files in the cloud backup server 105 prevents permanent loss of data if the storage medium 130 is compromised or destroyed.

The secure backup application 136 includes a malware detection module 138, a backup module 140 and a restore module 142. The backup module 140 routinely backs up one or more of the files 134 in the cloud backup server 105. Prior to backing up a particular file, the backup module 140 requests that the malware detection module 138 performs a scan on the file to determine whether the file is malware and, if possible, removes the detected malware. Malware can include any software that interferes with the normal operation of a computing device and includes viruses, malicious browser helper objects, hijackers, ransomware, keyloggers, backdoors, rootkits, Trojan horses, worms, malicious layered service providers, dialers, fraudtools, adware, spyware and so forth. If a particular file is malware and cannot be cleaned, then the backup module 140 prevents the file from being backed up.

The restore module 142 may restore files that have been backed up in the cloud backup server 105 to the client device 120C. Before completing restoration of a file, however, the restore module 142, like the backup module 140, requests that the malware detection module 138 perform a scan on the file to determine whether the file is malware. In some cases, even if the malware detection module 138 did not detect a file that is malware during back up, it may still determine that the file is malware upon restoration. This may occur, for example, if the malware detection module 138 is updated with new malware definitions after the initial back up but before restoration. If a file is determined to be malware, then the restore module 142 prevents the file from being restored.

By performing a per-file malware detection scan on backup and restoration, the secure backup application 136 securely backs up and restores files. Files that are backed up in the cloud backup server 105 may be shared with additional users or devices without incurring the risk of infection by malware. The following discussion describes the backup and restoration operations of the secure backup application 136 in greater detail.

### Secure Backup and Restoration

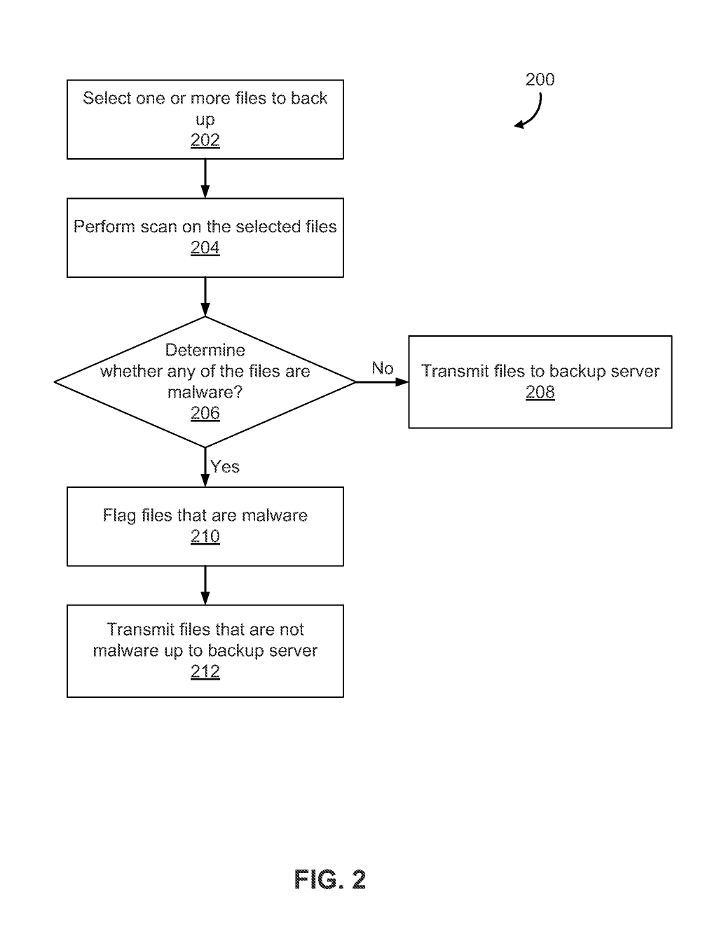

FIG. 2 is a flow diagram illustrating a process for securely backing up files to the cloud backup server 105, in accordance with an embodiment. The steps may be performed, for example, by the various modules within the secure backup application 136. In some implementations, the steps are performed in an order other than the order presented in FIG. 2, and in other implementations, additional or alternative steps may be performed.

In operation, the backup module 140 in the secure backup application 136 selects 202 one or more files from the files 134 to back up in the cloud backup server 105. In one embodiment, the secure backup application 136 operates on a schedule such that the backup module 140 determines after given periods of time whether to back up any of the files 134. The secure backup application 136 may also be invoked by a user of the client device 120C who wishes to create a backup of the files 134.

In one embodiment, the backup module 140 maintains, for each of the files 134, a backup status. The backup status for a particular file indicates when the file was last backed up in the cloud backup server 105. When determining whether to back up a particular file, the backup module 140 evaluates the backup status for the particular file to determine whether the file has been modified since the last back up. If the file has not been modified, then the backup module 140 determines that the files need not be backed up since no changes have been made and, consequently, the copy of the file in the cloud backup server 105 is current. Alternatively, if the file has been modified, then the backup module 140 determines to back up the file.

For each file that the backup module 140 selects to back up the malware detection module 138 performs 204 a malware detection scan on the file to determine whether the file is likely to be malware. The malware detection module 138 employs a number of detection techniques when scanning a file to determine whether the file is malware, such as viruses, worms and Trojan horses. In one technique, the malware detection module 138 maintains a library of malware definitions and compares the file, or portions thereof, to each of the malware definitions. If a substantial similarity is found between the file and a malware definition, then the file is determined to be malware. In another technique, the malware detection module 138 executes the file in a controlled environment and evaluates the behavior of the file and of the controlled environment. Certain behaviors, such as replication and file overwrites, are heuristically linked to malware. If such behaviors are present, then the file is determined to be malware.

Based on the scan performed by the malware detection module 138, the backup module 140 determines 206 whether any of the files in the set of files that were scanned are malware. If the backup module 140 determines 206 that none of the files is malware, then the backup module 140 transmits 208 each of the files to the cloud backup server 105 for backup. In one embodiment, the backup module 140 also updates the backup status of the files to indicate the timestamp when the files were transmitted to the cloud backup server 105.

If the malware detection module 138 determines 206 that one or more of the files are malware, then the backup module 140 flags 210 each of the files that are malware. In operation, the backup module 140 maintains an alert list identifying each of the files 134. For each file, the alert list includes an alert indicating whether the file was determined to be malware in a previous scan. When a file is flagged with an alert, the alert may be displayed to a user of the client device 120C to indicate that the file was not backed up because of malware detection. The alert may also be used in future backups to determine whether a particular file should be transmitted to the cloud backup server 105 for backup. Once the files that are malware are flagged, the backup module 140 transmits 212 the files that are not malware to the cloud backup server 105 for backup. In one embodiment, the backup module 140 also updates the backup status of the files to indicate the timestamp when the files were transmitted to the cloud backup server 105.

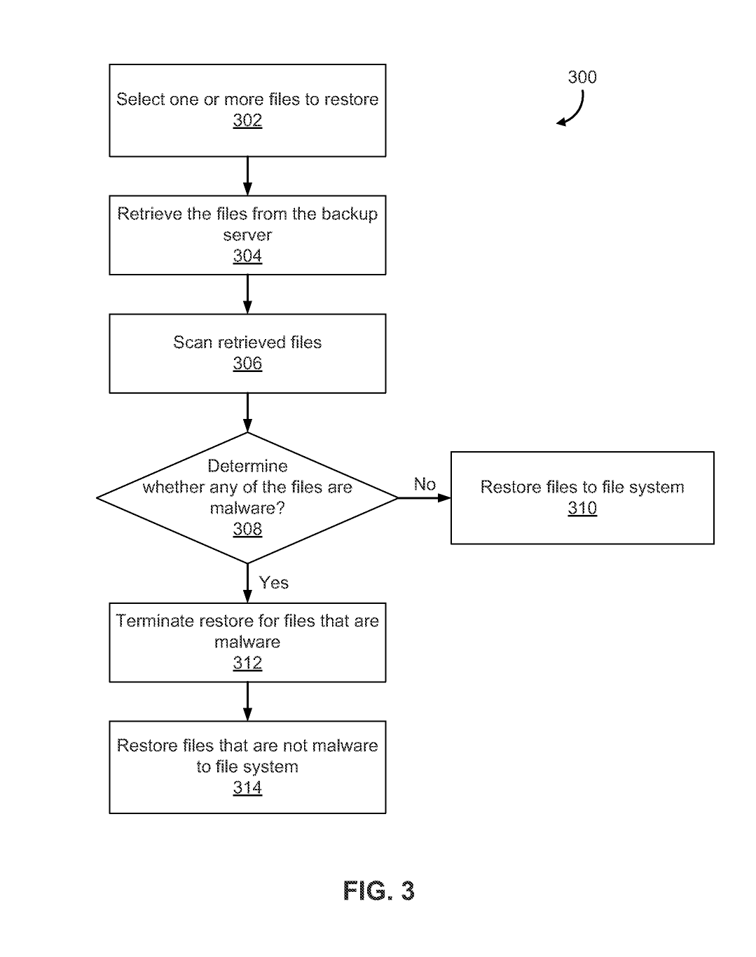

Files that are transmitted from the client device 120 to the cloud backup server 105 for backup may be restored to the client device 120C or may be restored to a different device. FIG. 3 is a flow diagram illustrating a process for securely restoring files from a cloud backup server, in accordance with an embodiment. The steps may be performed, for example, by the various modules within the secure backup application 136. In some implementations, the steps are performed in an order other than the order presented in FIG. 3, and in other implementations, additional or alternative steps may be performed.

In operation, the restore module 142 in the secure backup application 136 selects 302 one or more files of the files backed up in the cloud backup server 105 to restore to the client device 102. In one embodiment, the user requests that one or more of the files that are backed up in the cloud backup server 105 be restored and specifies the device(s) to which the files are to be restored. In an alternative embodiment, the secure backup application 136 executing on the client device 120C or on a different device automatically determines that one or more files in the cloud backup server 105 should be restored to the device. Such a determination may be based on the identity of the user operating the device or the determination of data loss from the device.

The restore module 142 retrieves 304 the one or more files from the cloud backup server 105. For each of the files, the malware detection module 138 scans 306 the file to determine whether the file is malware. Even if the malware detection module 138 did not detect malware when the file was originally backed up to the cloud backup server 105, the malware detection module 138 may still determine that the file is malware when the file is retrieved from the server 105. This may occur, for example, if the malware detection module 138 was updated with new malware definitions or heuristics that allow the malware detection module 138 to detect a broader range of malware at the time of the restore than when the file was originally backed up to the cloud backup server 105. This may also occur if the file transforms into malware while being stored in the cloud backup server 105.

Based on the scan performed by the malware detection module 138, the restore module 142 determines 308 whether any of the files that were scanned are malware. If the module 142 determines 308 that none of the files is malware, then the restore module 142 fully restores 310 each of the files to the file system of the client device 120C. Fully restoring a file may involve overwriting a version of the file that already exists within the files 134 or creating a new file in the file system that stores the content of the file retrieved from the cloud backup server 105.

If the restore module 142 determines 308 that one or more of the files are malware, then the restore module 142 terminates 312 the restoration of the files that are malware. When terminating the restoration of a file, the restore module 142 quarantines or permanently expunges the retrieved file and does not modify the file system of the client device 120C to include the contents of the file. The restore module 142 then restores 314 the remaining files (that are not malware) to the file system.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method for securely backing up files stored on a computing device, the method comprising:
identifying a plurality of files stored on a computing device for transmitting to a backup server for storage;
before transmitting the plurality of files to the back server, performing a malware detection scan individually on each of the plurality of files, the malware detection scan being configured to detect files that are malware;
determining, based on the malware detection scan, whether each of the plurality of files is malware;
transmitting to the backup server for storage the plurality of files subject to the determining, wherein each of the plurality of files is transmitted only if the file is not malware;
receiving a request to retrieve from the backup server a first file of the plurality of files that was transmitted to the backup server;
performing a second malware detection scan on the first file, the second malware detection scan being configured to detect files that are malware; and
restoring the first file only if the first file is not malware.

2. The method of claim 1, wherein determining comprises determining that a second file is malware, and further comprising flagging the second file as being malware.

3. The method of claim 2, further comprising generating a notification indicating that the second file is flagged as being malware.

4. The method of claim 1, wherein determining comprises determining that a second file is malware, and further comprising generating a notification indicating that the second file was not transmitted to the backup server for storage.

5. The method of claim 1, wherein performing the malware detection scan comprises:
comparing portions of each of the plurality of files to malware definitions.

6. The method of claim 1, wherein the performing the malware detection scan comprises:
evaluating behaviors of the computing device when each of the plurality of files are executed.

7. The method of claim 1, wherein receiving the request to retrieve the first file from the backup server comprises receiving a user request for restoring the first file to the computing device.

8. The method of claim 1, wherein receiving the request to retrieve the first file from the backup server comprises receiving a user request for restoring the first file to a second computing device.

9. A computer-readable storage medium storing instructions that, when executed by a processor, cause the processor to perform the steps of:
identifying a plurality of files stored on a computing device for transmitting to a backup server for storage;
before transmitting the plurality of files to the back server, performing a malware detection scan individually on each of the plurality of files, the malware detection scan being configured to detect files that are malware;
determining, based on the malware detection scan, whether each of the plurality of files is malware;
transmitting to the backup server for storage the plurality of files subject to the determining, wherein each of the plurality of files is transmitted only if the file is not malware;
receiving a request to retrieve from the backup server a first file of the plurality of files that was transmitted to the backup server;
performing a second malware detection scan on the first file, the second malware detection scan being configured to detect files that are malware; and
restoring the first file only if the first file is not malware.

10. The computer-readable storage medium of claim 9, wherein the instructions further cause the processor to perform the steps of determining that a second file is malware, and flagging the second file as being malware.

11. The computer-readable storage medium of claim 10, wherein the instructions further cause the processor to perform the step of generating a notification indicating that the second file is flagged as being malware.

12. The computer-readable storage medium of claim 9, wherein the instructions further cause the processor to perform the steps of determining that a second file is malware, and generating a notification indicating that the second file was not transmitted to the backup server for storage.

13. The computer-readable storage medium of claim 9, wherein performing the malware detection scan comprises:
comparing portions of each of the plurality of files to malware definitions.

14. The computer-readable storage medium of claim 9, wherein the performing the malware detection scan comprises:
evaluating behaviors of the computing device when each of the plurality of files are executed.

15. The computer-readable storage medium of claim 9, receiving the request to retrieve the first file from the backup server comprises receiving a user request for restoring the first file to the computing device.

16. The computer-readable storage medium of claim 9, wherein receiving the request to retrieve the first file from the backup server comprises receiving a user request for restoring the first file to a second computing device.

17. A computer-implemented method for securely backing up files stored on a computing device, comprising:
identifying a plurality of files stored on a computing device for transmitting to a backup server for storage;
before transmitting the plurality of files to the back server, performing a malware detection scan individually on each of the plurality of files, the malware detection scan being configured to detect files that are malware;
determining, based on the malware detection scan, whether each of the plurality of files is malware; and
transmitting to the backup server for storage the plurality of files subject to the determining, wherein each of the plurality of files is transmitted only if the file is not malware.

18. The method of claim 17, wherein determining comprises determining that a second file is malware, and flagging the second file as being malware.

19. The method of claim 17, wherein performing the malware detection scan comprises:
comparing portions of each of the plurality of files to malware definitions.

20. The method of claim 17, wherein the performing the malware detection scan comprises:
evaluating behaviors of the computing device when each of the plurality of files are executed.
